(19) United States
(12) Patent Application Publication
(10) Pub. No.: US 2011/0084942 A1
(43) Pub. Date: Apr. 14, 2011

(54) Data Processing Method and System with Multiple Input Units

(75) Inventors: Cheng-Lu Liu, Hsin-Chu (TW); Yun-Hsiang Yeh, Miaoli (TW)

(73) Assignee: WALTOP INTERNATIONAL CORPORATION, HSINCHU (TW)

(21) Appl. No.: 12/626,671

(22) Filed: Nov. 26, 2009

(30) Foreign Application Priority Data
Oct. 9, 2009 (TW) 098134390

(51) Int. Cl. G06F 3/033

(52) U.S. Cl. 345/179; 341/20

(57) ABSTRACT

Data processing method and system with multiple input units are disclosed. The method comprises the following steps. First of all, a plurality of antenna boards which are partially overlapped and form an integration antenna board with multiple regions are provided. Then signals from the antenna boards are processed through signal processing units corresponding to the antenna boards, and the processed signals are transmitted to an integration processing unit. Finally, the processed signals are integrated and processed via the integration processing unit and integrated signals of the integration antenna board are outputted.

### FIELD OF THE INVENTION

The present invention relates to data processing method and system with multiple input units, and more particularly to electromagnetic input method and system for multiple users.

### DESCRIPTION OF THE PRIOR ART

Digital tablets or electronic whiteboards are usually used each with a corresponding electromagnetic stylus or pen and hence only one user is available to use and operate. For digital tablets with a normal size, there is no particular need for simultaneous use of multiple users in view of the relative small size and the original design purpose of personal usage. However, for electromagnetic input apparatus with a relative large size such as an electronic whiteboard, there is a particular need for simultaneous use of multiple users in view of the relative large size and the design purpose of simultaneous use of multiple users such purposes of conference or classroom. Conventional electromagnetic input apparatus with a relative large size does not have the function of simultaneous use of multiple users and can not provide multiple regions for multiple users to operate simultaneously.

In order to solve the above-mentioned drawbacks of conventional electromagnetic input apparatus, the invention provides data processing method and system with multiple input units to effectively increase the function of electromagnetic input apparatus and to provide multiple regions for multiple users to operate simultaneously.

### SUMMARY OF THE INVENTION

An object of the present invention is to provide an electromagnetic input apparatus with multiple input units and signal processing units to provide multiple regions for simultaneously use of multiple users and much better performance comparing to the electromagnetic input apparatus with a single signal processing unit.

According to the object, one embodiment of the present invention provides a data processing method used on an electromagnetic input apparatus with multiple input units. The method comprises the following steps. First of all, a plurality of antenna boards which are partially superimposed are provided. Then signals from the antenna boards are processed through signal processing units connecting and corresponding to the antenna boards, and the processed signals are transmitted to an integration processing unit. Finally, the processed signals from all signal processing units are integrated and processed to generate integrated signals of the integrated antenna board, and the integrated signals of the integration antenna board are outputted through an input/output interface.

The invention also provides data processing system with multiple input units. The data processing system comprises a plurality of partially superimposed antenna boards, a plurality of signal processing units and an integration processing unit. The plurality of antenna boards sense a plurality of pointers and generate signals. The signal processing units corresponding to the antenna boards process the signals from the antenna boards. The integration processing unit integrates the processed signals to generate and output integrated signals.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 shows one embodiment of function structure of an electromagnetic input apparatus

FIG. 2 shows one embodiment of function structure of an electromagnetic input apparatus with multiple input units of the invention.

FIG. 3 shows one preferred embodiment of the data processing system with multiple input units of the invention.

FIGS. 4A to 4F show six embodiments of arrangements of a plurality of partially superimposed antenna boards of an electromagnetic input apparatus.

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the scale of each component may not be expressly exactly.

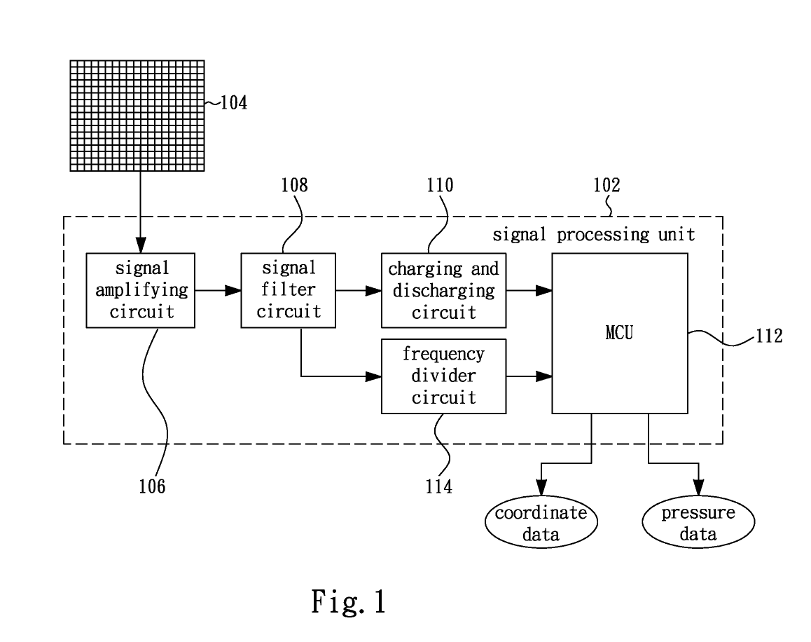

FIG. 1 shows one embodiment of function structure of an electromagnetic input apparatus comprising digital tablets or electronic whiteboards. The function structure of an electromagnetic input apparatus comprises a signal processing unit 102 which processes electromagnetic signals sensed by an antenna board 104 to generate coordinate data. Electromagnetic signals are generated when a pointer such as an electromagnetic stylus or pen approaches the antenna board 104. The antenna board 104 senses the electromagnetic signals and transmits to a signal amplifying circuit 106. The signal amplifying circuit 106 amplifies the signals and transmits to a signal filter circuit 108. The signal filter circuit 108 filters noises of the signals and transmits to a charging and discharging circuit 110. The signals then are converted to digital signals through an analog to digital converting process. The digital signals are then processed to generate coordinate data. Through the processing of frequency of the pointer of a frequency divider circuit 112 and the calculation of a micro-controller unit 114, pressure data of the pointer applied on the electromagnetic input apparatus can also be generated. The coordinate data and the pressure data are then outputted through an interface such as RS-232 or USB.

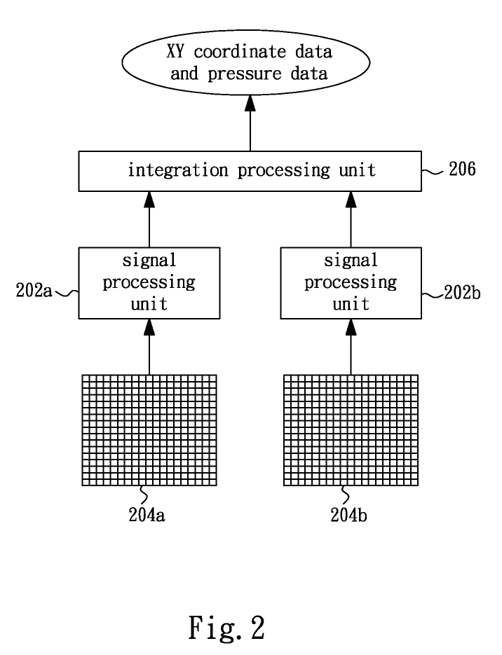

FIG. 2 shows one embodiment of function structure of an electromagnetic input apparatus with multiple input units of the invention. In one embodiment, a plurality of antenna boards are partially superimposed to form an electronic whiteboard or a digital tablet with a relative large size. Each antenna board connects to a signal processing unit to processes electromagnetic signals sensed by the antenna board to process and generate coordinate and pressure data. An integration processing unit is used to process and integrate the coordinate and pressure data from each signal processing unit. As shown in FIG. 2, signal processing units 202a and 202b process coordinate and pressure signals sensed by antenna boards 204a and 204b. The signal processing units 202a and 202b then transmit the processed coordinate and pressure signals to an integration processing unit 206. The integration processing unit 206 then process and integrate the coordinate and pressure data from the signal processing unit 202a and 202b. The purpose of using multiple signal processing units is to increase the performance of the electromagnetic input apparatus. Through the combination of multiple antenna boards and multiple signal processing units to provide multiple regions, multiple users can use and operate the electromagnetic input apparatus simultaneously.

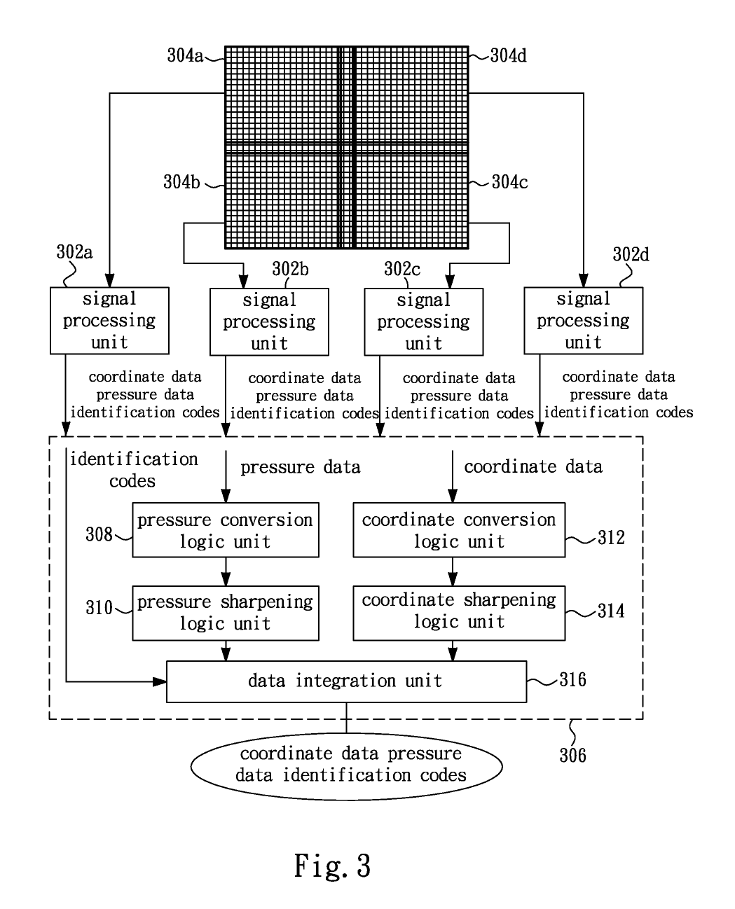

FIG. 3 shows one preferred embodiment of the data processing system with multiple input units of the invention. As shown in FIG. 3, 4 antenna boards 304a˜304d are partially superimposed to form an electromagnetic input apparatus such as electronic whiteboard or a digital tablet with a relative large size. The antenna boards 304a˜304d connect to signal processing unit 302a and 302d respectively to process electromagnetic signals sensed by the antenna boards 304a˜304d. When four users use pointers such as an electromagnetic pens or styluses to operate on the antenna boards 304a˜304d respectively, the antenna boards 304a˜304d transmit sensed coordinate and pressure signals to the signal processing unit 302a and 302d. The signal processing unit 302a and 302d transmit the coordinate and pressure signals and identification codes of antenna boards 304a˜304d to an integration processing unit 306 after signal amplifying, noise filtering, analog to digital conversion, coordinate data conversion, and calculation of pressure data. The integration processing unit 306 processes and integrates various signals from the signal processing unit 302a and 302d according to corresponding application. The signals from the signal processing unit 302a and 302d include coordinate signals, antenna digital signals, pressure signals, frequency signals and identification codes. The integration processing unit 306 outputs data of the electromagnetic input apparatus, coordinate data, pressure data or other specific data after processing signals from the signal processing units 302a and 302d. In one embodiment, the integration processing unit 306 comprises a coordinate conversion logic unit 312 and a coordinate sharpening logic unit 314 to integrate coordinate data from the signal processing units 302a and 302d. The integration processing unit 306 further includes a pressure conversion logic unit 308 and a pressure sharpening logic unit 310 to integrate pressure data of a pointer from the signal processing units 302a and 302d. A data integration unit 316 integrates and outputs the coordinate data, the pressure and the data identification codes of antenna boards 304a˜304d through an input/output interface.

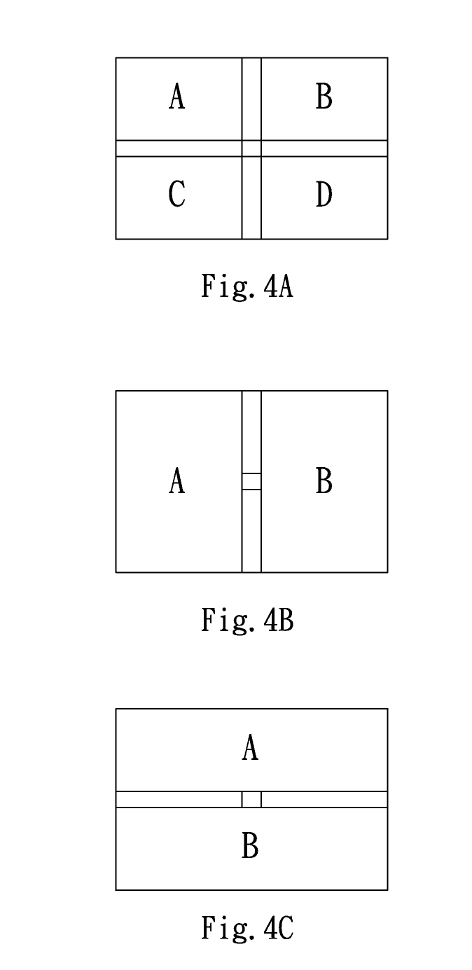

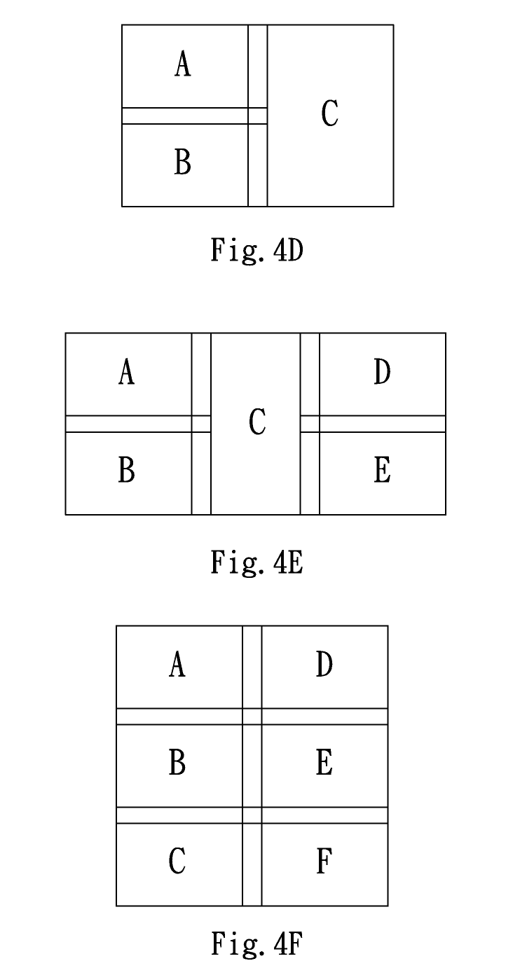

FIGS. 4A to 4F show six embodiments of arrangements of a plurality of partially superimposed antenna boards of an electromagnetic input apparatus. FIG. 4A shows four antenna boards A˜D partially superimpose to form a large size antenna board and to provide four regions for simultaneously use of four users. FIGS. 4B and 4C shows four antenna boards A and B partially superimpose to form a large size antenna board and to provide two regions for simultaneously use of two users. FIG. 4D shows three antenna boards A˜C partially superimpose to form a large size antenna board and to provide three regions for simultaneously use of three users. FIG. 4E shows five antenna boards A˜E partially superimpose to form a large size antenna board and to provide five regions for simultaneously use of five users. FIG. 4F shows six antenna boards A˜F partially superimpose to form a large size antenna board and to provide six regions for simultaneously use of six users.

The data processing method used on an electromagnetic input apparatus with multiple input units comprises the following steps. First of all, a plurality of antenna boards which are partially overlapped and form an integrated antenna board with multiple regions are provided. Then signals from the antenna boards are processed through signal processing units corresponding to the antenna boards, and the processed signals are transmitted to an integration processing unit. The signals include coordinate signals and pressure signals of pointers applied on the antenna boards, and identification codes of the antenna boards. Finally, the processed signals from all signal processing units are integrated and processed to generate integrated signals of the integrated antenna board including integrated coordinate signals and pressure signals of pointers and the identification codes of the antenna boards via the integration processing unit, and the integrated signals of the integration antenna board are outputted through an input/output interface.

The invention provides an electromagnetic input apparatus with multiple input units and a large size antenna board by superimposing a plurality of antenna boards to form and provide multiple regions for simultaneously use of multiple users. When multiple users simultaneously use pointers on the antenna boards, signal sensed by each antenna board is processed by the corresponding signal processing unit to generate coordinate data, pressure data of the pointer. Each signal processing unit processes and transmits the coordinate data, pressure data of the pointer and the identification code of the antenna board to an integration processing unit. The integration processing unit integrates and converts the coordinate data, pressure data of the pointer and the identification code of the antenna board to integrated coordinate data, pressure data of all pointers applied on the whole integrated antenna board without lowering the performance and the problem and difficulty of manufacturing large size printed circuit boards can be overcame.

Although specific embodiments have been illustrated and described, it will be appreciated by those skilled in the art that various modifications may be made without departing from the scope of the present invention, which is intended to be limited solely by the appended claims.

What is claimed is:

1. A data processing method for an electromagnetic apparatus with multiple input units, said method comprising:
providing a plurality of antenna boards which are partially superimposed to form an integrated antenna board with multiple regions;
processing signals from the antenna boards through a plurality of signal processing units corresponding to the antenna boards, and transmitting the processed signals to an integration processing unit; and
integrating the processed signals by the integration processing unit to generate and output integrated signals of the integrated antenna board.

2. The method according to claim 1, wherein the antenna boards comprise antenna boards of an electronic whiteboard.

3. The method according to claim 1, wherein the signals comprise coordinate data and pressure data of pointers applied on the antenna boards and identification codes of the antenna boards.

4. The method according to claim 3, wherein the pointer comprises an electromagnetic pen.

5. A data processing system with multiple input units, said data processing system comprising:
a plurality of antenna boards which are partially superimposed to sense a plurality of pointers and generate signals;
a plurality of signal processing units corresponding to the antenna boards processing the signals from the antenna boards; and
an integration processing unit integrating the processed signals to generate and output integrated signals.

6. The data processing system according to claim 5, wherein the antenna boards comprise antenna boards of an electronic whiteboard.

7. The data processing system according to claim 5, wherein the pointer comprises an electromagnetic pen.

8. The data processing system according to claim 5, wherein the signal processing unit comprises:
a signal amplifying circuit amplifying the signals;
a signal filter circuit filtering noises of the signals;
a charging and discharging circuit converting the signals to digital signals through an analog to digital converting process;
a frequency divider circuit processing frequency of the signal; and
a micro-controller unit calculating the digital signals to generate coordinate data and converting the frequency of the signal to pressure data.

9. The data processing system according to claim 5, wherein the signals comprise coordinate data and pressure data of pointers applied on the antenna boards and identification codes of the antenna boards.

10. The data processing system according to claim 9, wherein integrated signals comprise coordinate data and pressure data of pointers applied on the antenna boards and identification codes of the antenna boards.

11. The data processing system according to claim 9, wherein the integration processing unit comprises:
a coordinate conversion logic unit and a coordinate sharpening logic unit to integrate the coordinate data from the signal processing units;
a pressure conversion logic unit and a pressure sharpening logic unit to integrate pressure data of a pointer from the signal processing units; and
a data integration unit integrating and outputting the coordinate data, the pressure and the data identification codes of antenna boards from the signal processing units through an input/output interface.
